(19) United States
(12) Patent Application Publication
(10) Pub. No.: US 2025/0272625 A1
(43) Pub. Date: Aug. 28, 2025

(54) PLANNING LOGIC EVALUATION SUPPORT SYSTEM AND METHOD

(71) Applicant: Hitachi, Ltd., Tokyo (JP)

(72) Inventors: Kohei MIYATA, Tokyo (JP); Norisuke FUJII, Tokyo (JP); Takeru DOAN, Tokyo (JP)

(21) Appl. No.: 18/858,795

(22) PCT Filed: Mar. 30, 2023
(86) PCT No.: PCT/JP2023/013239

§ 371 Date: Oct. 22, 2024

(30) Foreign Application Priority Data
Sep. 28, 2022 (JP) 2022-155060

(51) Int. Cl. G06Q 10/0631

(52) U.S. Cl. CPC G06Q 10/06311

(57) ABSTRACT

A problem that is addressed by the invention as claimed in the application concerned resides in providing a tool for facilitating the introduction of a scheduler. One aspect of the present invention is a planning logic evaluation support system equipped with a control unit, a storage unit, an input unit, and an output unit and comprising a process characteristic analysis unit to extract process characteristics from master data; a productivity reduction factor extraction unit to extract noticeable characteristic parameters that have an effect on productivity based on the process characteristics; and a test production data generation unit to generate production data for testing in which the noticeable characteristic parameters are dispersed in a certain scope.

### TECHNICAL FIELD

The present invention relates to technology to introduce logics for a system to make a plan such as a production plan.

### BACKGROUND ART

Schedulers are becoming more important lately, as production execution immediately responding to changes in manufacturing environment is required. A production scheduler, as an example of schedulers, is a system or software for optimal assignments of raw materials and production resources in order to meet demand.

For instance, assuming that an industrial product is produced, a production scheduler takes input of quantities of resources including materials, processing machinery, workers, etc., warehousing and supply timing, the specifications of a product to be produced, and its delivery date; then, it determines an optimal production schedule (production plan).

Practical use of a production scheduler involves the steps of input modeling, designing and implementing logics to decide rules to be followed by a plan, and making a production plan by the production scheduler. After making a plan, work instructions are given and progress management is performed according to the plan.

Some production schedulers as such are already productized and commercially available. There is, e.g., Patent Literation 1 that concerns designing and implementing logics.

Patent Literature 2 is intended to provide technology to support identifying a scheduling method depending on production process characteristics and described therein is a characteristic extraction unit that extracts characteristic information corresponding to the production process characteristics from manufacturing information about product manufacture.

Patent Literature 3 discloses technology to determine excess or deficiency of test cases for testing logics.

### CITATION LIST

### Patent Literature

Patent Literature 1: Japanese Unexamined Patent Application Publication No. 2021-11193

Patent Literature 2: WO 2017/103996 A1

Patent Literature 3: Japanese Unexamined Patent Application Publication No. 2007-26360

### SUMMARY OF INVENTION

### Technical Problem

Introduction of a production scheduler begins with an operation in which a worker organizes requirements on Key Performance Indicators (KPIs) that the worker wants to improve, the characteristics of production lines, etc., as is the case for designing a general system. To develop a production scheduler in accordance with the requirement, the worker performs production line modeling and designing logics for making a production plan fit for the modeling. The worker builds a production scheduler according to these model and logics and puts the scheduler into practical use by implementing it in a production planning system.

However, the foregoing operations of production line modeling and planning logic designing depend on know-how and this impedes the introduction of a scheduler. In introducing a scheduler, for instance, such a case is foreseeable that a great number of items have to be set regarding modeling and planning logics and such setting task can only be performed by experts.

As the items to be set, e.g., the following should be set: setting for dispatching rules for delivery to equipment; a selection criterion as to what order in which resources should be selected; an assignment direction; lot size setting; whether or not to split a lot; or resource occupation conditions, among others.

Because setting these items becomes a hurdle, the introduction of a scheduler is not progressing and long-term work is required for the introduction.

Thus, a problem that is addressed by the invention as claimed in the application concerned resides in providing a tool for facilitating the introduction of a scheduler.

### Solution to Problem

One aspect of the present invention is a planning logic evaluation support system equipped with a control unit, a storage unit, an input unit, and an output unit and including: a process characteristic analysis unit to extract process characteristics from master data; a productivity reduction factor extraction unit to extract noticeable characteristic parameters that have an effect on productivity based on the process characteristics; and a test production data generation unit to generate production data for testing in which the noticeable characteristic parameters are dispersed in a certain scope.

Another aspect of the present invention is a planning logic evaluation support method that is executed by an information processing device equipped with a control unit, a storage unit, an input unit, and an output unit, the method including a process characteristic analysis step to extract process characteristics from master data; a productivity reduction factor extraction step to extract noticeable characteristic parameters that have an effect on productivity based on the process characteristics; and a test production data generation step to generate production data for testing in which the noticeable characteristic parameters are dispersed in a certain scope.

### Advantageous Effects of Invention

According to the present invention, it is possible to provide a tool that facilitates scheduler introduction.

### BRIEF DESCRIPTION OF DRAWINGS

FIG. 1 is a block diagram depicting an overall configuration of a planning logic evaluation support device of an embodiment.

FIG. 2 is a tabular diagram exemplifying a process master.

FIG. 3 is a tabular diagram exemplifying an equipment master.

FIG. 4 is a tabular diagram exemplifying a setup master.

FIG. 5 is a flowchart illustrating a process of the planning logic evaluation support device.

FIG. 6 is a flowchart exemplifying detail of analysis of process characteristics.

FIG. 7 is a graphical diagram exemplifying a graphical structure of a process flow.

FIG. 8 is a tabular diagram exemplifying process characteristic data.

FIG. 9 is a tabular diagram exemplifying productivity reduction factor data.

FIG. 10 is a flowchart exemplifying detail of generation of production data for testing.

FIG. 11 is a diagram conceptually illustrating generation of production data for testing.

FIG. 12 is an image diagram of a screen for generating production data for testing on planning logics.

### DESCRIPTION OF EMBODIMENTS

In the following, an embodiment is described in detail with the aid of drawings. However, the present invention should not be construed to be limited to the following descriptions of the embodiment. Those skilled in the art will readily understand that modifications may be made to specific configurations of the present invention without departing from the spirit or gist of the invention.

In configurations of the invention, which will be described hereinafter, to denote identical parts or parts having like functions, identical reference numerals are used in common across different drawings and duplicated description may be omitted.

When a plurality of elements having the same function or similar functions exist, they may be mentioned and identified by using the same reference numeral with different subscripts. However, when there is no need to individualize the plurality of elements, they may be mentioned without using the subscripts.

Notation of “first”, “second”, “third”, etc. herein, among others, is prefixed to identify components, but it is not necessarily intended to confine the components to a certain number, sequence, or contents. Besides, numbers to identify components are used on a per-context basis; a number used in one context does not always denote the same component in another context. Additionally, it is not precluded that a component identified by a number also functions as a component identified by another number.

In some cases, the position, size, shape, range, etc. of each component depicted in a drawing or the like may not represent its actual position, size, shape, range, etc. with the intention to facilitate understanding of the invention. Hence, the present invention is not necessarily to be limited to a certain position, size, shape, range, etc. disclosed in a drawing or the like.

Publications, patents, and patent applications cited herein constitute part of the description herein as is.

As discussed previously, the introduction of a production scheduler involves production line modeling based on master data representing the specifications of a product, equipment, and processes and designing logics for making an effective production plan fit for the modeling. Designing logics requires setting various items to be set (such as dispatching rules, a resource selection criterion, an assignment direction, whether or not to split a lot, and resource occupation conditions). Once having been designed, the logics are implemented in a production scheduler and scheduling is performed with input of production data for testing. A result of the scheduling is evaluated based on optional KPIs (such as an operation ratio and an on-time delivery rate) and the logics are evaluated (tested) as to whether or not they are actually effective. If a result of the evaluation is good, the logics are put in implementation and practical use. If the logics are not effective, the settings of the items to be set are reviewed and logics are designed again. Production data for testing (or practical operation) includes, e.g., products to be produced and their quantity and delivery date.

In a process of evaluating the planning logics when the scheduler as above is introduced, it is required to create production data for testing so as to cover circumstances where productivity is liable to decline and verify if the planning with the data brings good results. However, in a case where production data for testing is created utilizing, inter alia, past performance data and evaluation is made, verification as such may be impossible, as the production data does not necessarily include data on the circumstances where productivity is liable to decline. For instance, even if an operation ratio is evaluated based on last year's performance data in which tact balance between equipment is good, the verification becomes impossible for a case when the balance has become worse in this year.

To avoid inadequate verification, it is required to prepare production data for testing that covers circumstances where productivity is liable to decline and know-how is needed to do. To facilitate the verification, it is needed to create production data for testing without know-how.

In this regard, it may be conceivable to assign and disperse parameters to be input to the scheduler to generate production data for testing. Nevertheless, if there are numerous parameters, the number of test cases will become huge to make it hard to make result evaluation.

In an embodiments that follows, production data for testing is created for a narrowed down number of circumstances for which testing should be performed without omission of circumstances where productivity is liable to decline and an evaluation is made if planning with the data brings good results. In a productivity perspective, the inventors take notice of a fact that there is a correlation between process flow characteristics and productivity reduction factors and made it possible to narrow down the number of circumstances for which testing should be performed. In this embodiment, it is proposed to facilitate to implement the scheduler by providing technology to support the evaluation of planning logics in introducing an execution scheduler.

To give a concrete example, from the characteristics of a production process, a system of an embodiment identifies parameters (referred to as noticeable characteristic parameters) that have a great effect on productivity (represented by KPIs, for example) in the production process having those characteristics. The system sets test points so that noticeable characteristic parameters will vary across a certain scope, creates production data having the noticeable characteristic parameters of the test points, and applies the production data for testing.

### FIRST EMBODIMENT

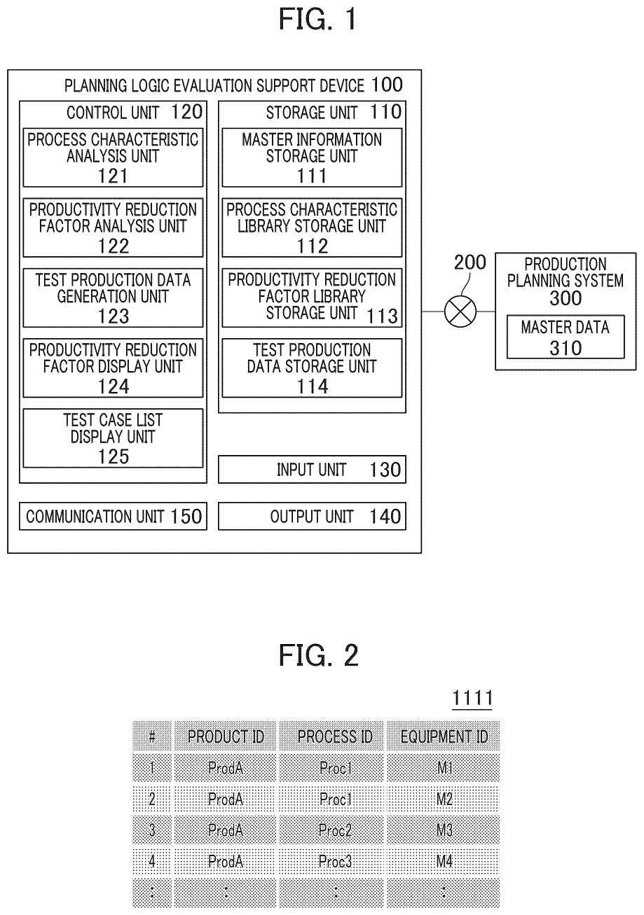

FIG. 1 is a block diagram depicting an overall configuration of a planning logic evaluation support device of an embodiment. The planning logic evaluation support device 100 can generally be configured by utilizing an information processing device such as a server. Like a general server, it is equipped with a storage unit 110, a control unit 120, an input unit 130, an output unit 140, a communication unit 150, etc. as hardware components.

The storage unit 110 can be configured by various combinations of a volatile semiconductor memory like a Dynamic Random Access Memory (DRAM) in this embodiment, a magnetic disc device, a nonvolatile semiconductor memory, etc., depending on the purpose.

The control unit 120 is a part that performs various processing tasks; by way of example, it is implemented through the execution of programs stored in the storage unit 110 by a Central Processing Unit. In FIG. 1, software implemented functions are represented as respective functional blocks as follows: a process characteristic analysis unit 121; a productivity reduction factor analysis unit 122; a test production data generation unit 123; a productivity reduction factor display unit 124; and a test case list display unit 125. The function of each unit will be described later accompanied with a process flow.

For the input unit 130, commonly known components such as a keyboard and a mouse can be used. For the output unit 140, commonly known components such as a display device and a printer can be used. The communication unit 150 is an interface to communicate with resources outside the planning logic evaluation support device 100.

The planning logic evaluation support device 100 is capable of communicating with a production planning system 300 through the communication unit 150 and via an external network 200. The network 200 may be configured as a wired or wireless one. Note that the respective elements of the planning logic evaluation support device 100 may also be configured by utilizing an external information processing device connected via the network 200 and it is not necessary to configure them in a single information processing device. For example, they can be configured as clouds.

The production planning system 300 can be configured by utilizing an information processing device such as a server and a production scheduler discussed previously is implemented by software in it. The production planning system 300 beforehand stores therein information about production resources such as, e.g., manufacturing machinery and the number of workers, information about products to be produced, information about parts to be used in a product, information about order of processes, etc., as master data 310. Then, it reproduces a production environment using the master data 310.

In order to, for example, minimize manufacturing cost or maximize throughput, the production planning system 300 outputs a production plan as regards: when a production is scheduled to run; how many and what product they will make; how many persons are engaged in the production; and what equipment they will use for the production. A production scheduler generates planning logics for outputting a production plan, based on the master data and items to be set that have been set by a user.

Because some production schedulers are already commercially available and basic scheduler configurations are publicly known, detailed descriptions thereof are omitted. Typically, the production scheduler sets what product is to be produced and its quantity and delivery date based on the foregoing master data and assigns a plurality of orders of manufacture to production resources according to assignment order in conformity with the items to be set that haven been set beforehand. It visually outputs a result of the assignment in a Gantt chart, for example.

When generating planning logics, an operator has to set items to be set as constraints. The items to be set are, e.g., priority of assignment order when a plurality of sets of production resources can be used, priority of order when a plurality of work tasks exist, manufacturing lot size, setup time, process-to-process moving time, etc.; know-how of experts who well know on-site situation is often reflected in settings of these items to be set.

While performance of planning logics depends on what settings done for the items to be set, planning logics having once been created are typically tested and evaluated and generating planning logics is repeated until a satisfactory evaluation result is obtained. In this embodiment, a method for appropriately evaluating planning logics is proposed.

The configuration and operation of the planning logic evaluation support device 100 in FIG. 1 are described sequentially. In a master information storage unit 111, e.g., the copy of the whole or part of the master data 310 within production planning system 300 is stored. In this example, a process master, an equipment master, and a setup master are included in the master information storage unit 111.

FIG. 2 is a tabular diagram exemplifying a process master. Data representing production processes for each product to be produced is stored in the process master 1111. In the example of the process master 1111 in FIG. 2, with the product ID of each product to be produced, the process ID of a process necessary for the production and the equipment ID of an equipment necessary for the process are correlated. A business operator that carries out production should digitalize the process master 1111 in advance.

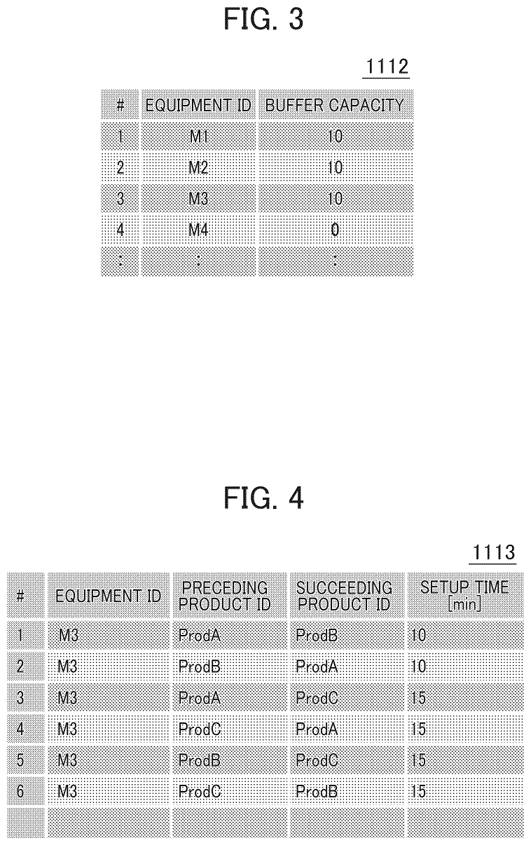

FIG. 3 is a tabular diagram exemplifying an equipment master. Data about equipment to be used for each production process is stored in the equipment master 1112. In the example of the equipment master 1112 in FIG. 2, correlated with the equipment ID of each equipment, the specifications of the equipment are stored. In the example of FIG. 3, by way of example, the capacity of a buffer that is provided upstream of each equipment in the process is stored. A concrete example of the buffer is a storage place where unfinished products are put in, installed before the equipment. A business operator that carries out production should digitalize the equipment master 1112 in advance.

FIG. 4 is a tabular diagram exemplifying a setup master. Data about setup involved in a production process is stored in the setup master 1113. Herein, setup refers to an operation including installation of processing machinery, jigs, devices, etc. and reconfiguration fit for a product to be produced. In the example of the setup master 1113 in FIG. 4, correlated with the equipment ID of an equipment for which setup should be performed, the preceding product ID of a preceding product, the succeeding product ID of a succeeding product, and setup time it takes for the setup are stored. A business operator that carries out production should digitalize the setup master 1113 in advance.

The examples of data in FIGS. 2 to 4 are simplified and these masters may further include other information in practical usage. The planning logic evaluation support device 100 of this embodiment analyzes production process characteristics based on the master data mentioned above and extracts productivity reduction factors from the analyzed production process characteristics. Then, it generates production data for testing sensitive to the productivity decline. Note that: in this embodiment, an example is given in which analyzing production process characteristics is performed using the process master 1111, equipment master 1112, and setup master 1113; however, other data about production processes may be used instead of or in addition to such data in these masters.

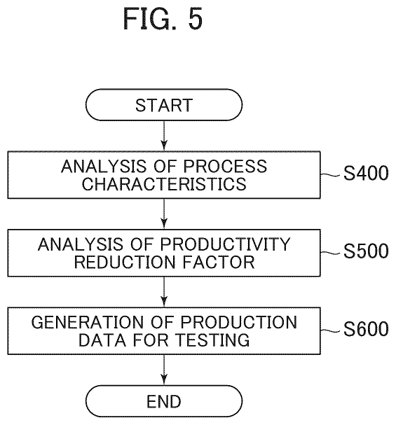

An example of a process flow of the planning logic evaluation support device 100 is illustrated in FIG. 5. The process characteristic analysis unit 121 performs analysis of process characteristics S400 based on master information in the master information storage unit 111. The productivity reduction factor analysis unit 122 performs analysis of productivity reduction factors S500 based on a result of the analysis of the characteristics S400. The test production data generation unit 123 performs generation of production data for testing S600 based on a result of the analysis of productivity reduction factors S500.

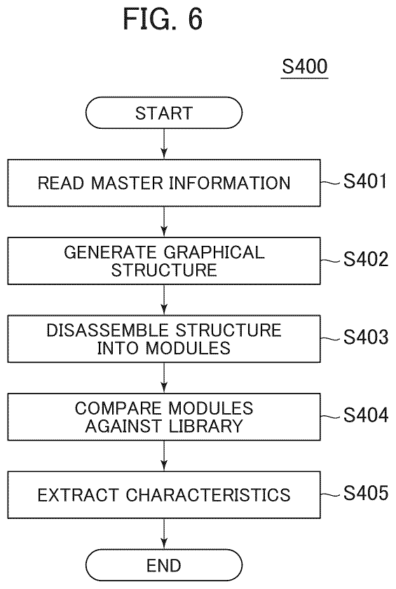

FIG. 6 exemplifies a detailed flow of analysis of process characteristics S400. First, the process characteristic analysis unit 121 reads the process master 1111, equipment master 1112, and setup master 1113 from the master information storage unit 111 (S401).

The process characteristic analysis unit 121 generates connection relationship mapping among equipment buffers, and setup in a graphical structure from the read process master 1111 information and equipment master 1112 and setup master 1113 information (S402).

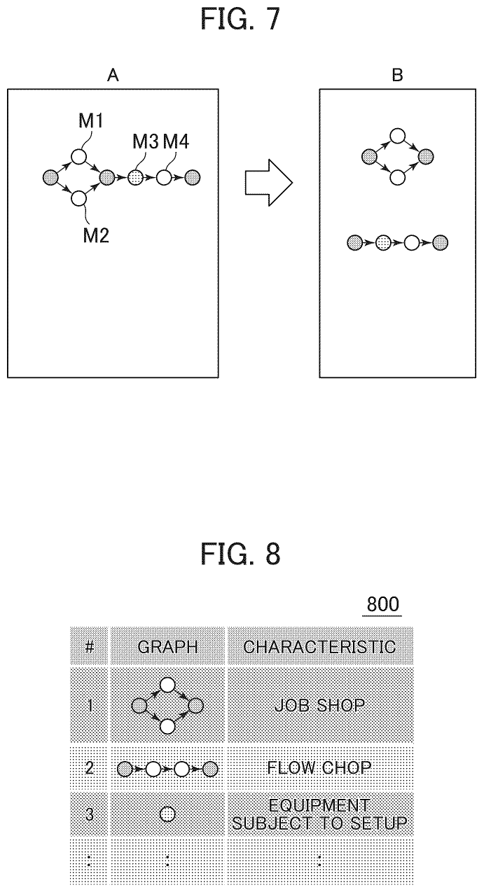

A in FIG. 7 is an example of a graphical structure of a process flow generated by the process characteristic analysis unit 121 based on data in FIG. 2, FIG. 3, and FIG. 4. To generate such a graphical structure, one equipment should expediently be linked to another serially in the ID order of processes. In the graphical structure in FIG. 7, white circle marking denotes an equipment (without need of setup), black circle marking denotes a buffer, and gray circle marking denotes an equipment (with need of setup).

The equipment master 1112 in FIG. 3 is assumed to indicate buffers that are installed before each equipment. It is noticed from the equipment master 1112 in FIG. 3 that capacity of each buffer installed before equipment “M1”, “M2”, and “M3”, respectively, is 10 (in optional units) and there is no buffer before equipment “M4”.

It is noticed from the process master 1111 in FIG. 2 that both equipment with IDs “M1” and “M2” can be used for a process with the process ID “Proc1”. Therefore, the graphical structure of the process flow, A in FIG. 7, diverges into the equipment “M1” and “M2” from a buffer (with capacity of 10) at a start point.

It is noticed from the process master 1111 in FIG. 2 that only an equipment with ID “M3” can be used for a subsequent process with the process ID “Proc2”. Therefore, the graphical structure of the process flow diverged into “M1” and “M2” converges to “M3”. It is noticed from the equipment master in FIG. 3 that a buffer is installed before “M3”.

Besides, it is noticed from the setup master 1113 in FIG. 4 that “M3” is an equipment with need of setup and setup is required when changing the product to be produced. Therefore, “M3” is marked by gray circle that denotes an equipment with need of setup.

It is noticed from the process master 1111 in FIG. 2 that a process that follows “M3” is “M4” and “M4” has no buffer. Therefore, there is no buffer between “M3” and “M4”. Note that such a rule is provided that a process always terminates on a buffer.

Note that: information on buffers is stored in the equipment master 1112 in the foregoing example; however, there is another way in which a buffer master that correlates equipment ID and buffer ID is provided separately to improve versatility. Additionally, although the setup master 1113 is provided separately in the foregoing example, setup information may be added to the equipment master 1112. That is, data form is free, provided that data represents process characteristics.

Then, returning to FIG. 6, the process characteristic analysis unit 121 disassembles the graphical structure of the process flow into modules by dividing it at a buffer (S403).

B in FIG. 7 gives an illustration in which the graphical structure, A in FIG. 7, is divided at a buffer marked by black circle and two modules are extracted.

Then, the process characteristic analysis unit 121 compares the extracted modules against process characteristic data stored in a process characteristic library storage unit 112 and extracts the process flow characteristics (S404).

FIG. 8 is one example of process characteristic data 800 stored in the process characteristic library storage unit 112. Correlated with the parts of the graphical structure of a process, their characteristics are stored. Experts should beforehand create process characteristic data 800 based on on-site know-how and store it as library data.

In the example of FIG. 8, with a graph in which equipment are arranged in a parallel structure, a job shop is correlated that is a characteristic of a process with machinery equipment having the same kind of function and performance being grouped and organized (#1). Also, with a graph in which equipment are arranged in a serial structure, a flow shop is correlated that is a characteristic of a process with the equipment being organized along the flow of the same processing path (#2). Also, when an equipment subject to setup exists, equipment subject to setup is correlated with it (#3).

In the example of this embodiment, as a result of extracting characteristics by the process characteristic analysis unit 121, it is found out that the target process incorporates the characteristics as follows: job shop; flow shop; equipment subject to setup (S405).

In the embodiment described hereinbefore, a process is divided into modules, as illustrated in FIG. 7, and its characteristics are extracted by comparing the modules against process characteristic data 700. As another example, it is also possible to extract such characteristics using, inter alia, a neural network subjected to machine learning; by inputting data in the process master, equipment master, and setup master to the neural network, then it outputs the characteristics of a process. As machine learning, inter alia, supervised learning which is publicly known can be used; detail thereof is omitted.

Returning to FIG. 5, the productivity reduction factor analysis unit 122 performs analysis of productivity reduction factors based on a result of the extraction of the characteristics, namely, the process flow characteristics received from the process characteristic analysis unit 121 (S500).

The productivity reduction factor analysis unit 122 refers to a productivity reduction factor library storage unit 113 and identifies productivity reduction factors correlated with the process flow characteristics.

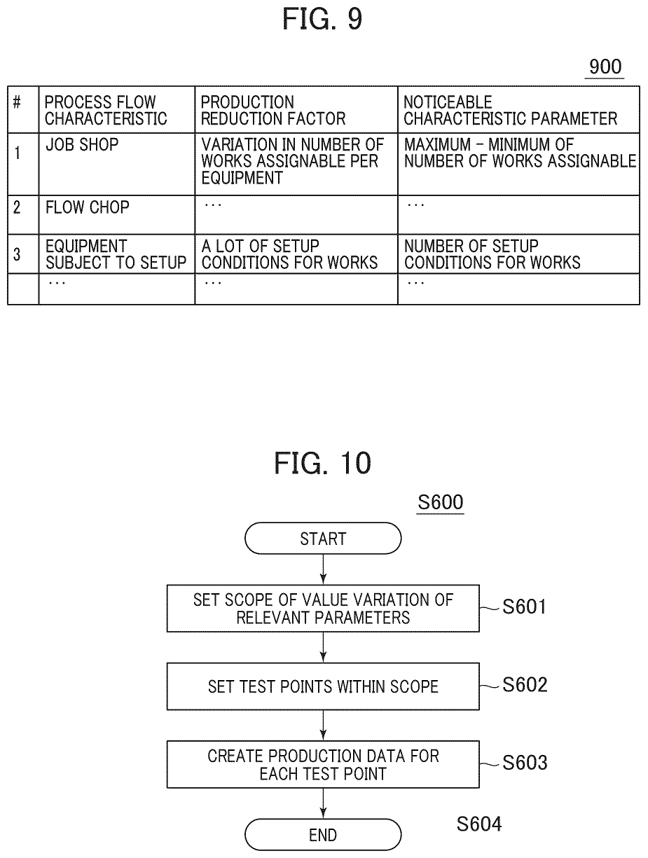

FIG. 9 exemplifies productivity reduction factor data 900 stored in the productivity reduction factor library storage unit 113. Correlated with the process flow characteristics, productivity reduction factors are stored. Experts who have knowledge of productivity reduction factors should beforehand create productivity reduction factor data 900 based on on-site know-how and store it as library data.

For example, correlated with “job shop”, which is a characteristic of the process flow, “variation in the number of works assignable per equipment” is stored. For a case where a job shop is incorporated in a process flow, this data is set by experts, based on on-site know-how; specifically, variation in the number of works (workpieces to be processed) per equipment is a possible factor that causes productivity reduction. Accordingly, a noticeable characteristic parameter that is needed to select production test data making this factor of productivity reduction apparent is “difference between the maximum and minimum values of the number of works assignable”. As a concrete example of production data for testing to reduce productivity, such data is used that makes a large variation in the number of works assignable and causes intensive input of works assignable to a particular equipment only.

Besides, for a case where an equipment subject to setup is incorporated in a process flow, there is another on-site know-how; specifically, a lot of setup conditions for works becomes a factor causing productivity reduction. In this case, the “number of setup conditions for works” is a noticeable characteristic parameter.

In this embodiment, in correlation with process flow characteristics, noticeable characteristic parameters that have a great effect on productivity are identified and production data for testing is generated so that the noticeable characteristic parameters will vary. It is possible to identify parameters (a product to be input, its quantity, shift, etc.) that are significant for productivity; this enables it to narrow down the number of circumstances for which testing should be performed and to evaluate planning logics efficiently.

Returning to FIG. 5, the test production data generation unit 123 performs generation of production data for testing based on the productivity reduction factors received from the productivity reduction factor analysis unit 122 (S600).

FIG. 10 exemplifies a detailed flow of generation of production data for testing S600. First, for the noticeable characteristic parameters extracted as a result of the analysis of productivity reduction factors S500, the test production data generation unit 123 sets a scope of value variation of each parameter. Here, an explanation is provided taking “maximum-minimum of the number of works assignable” and the “number of setup conditions for works” as examples of the noticeable characteristic parameters. Here, it is decided to set best and worst values to define a scope across which the related parameters will vary.

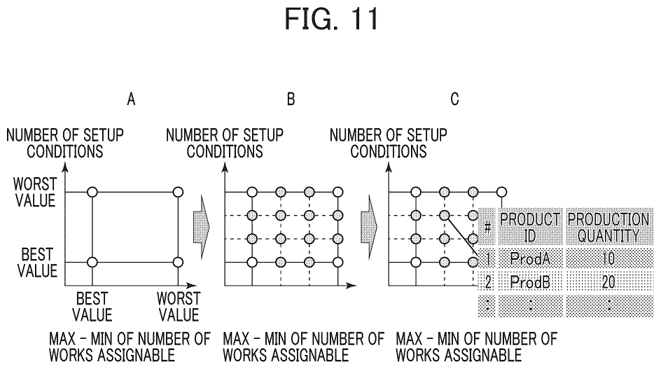

FIG. 11 conceptually illustrates the generation of production data for testing S600. A in FIG. 11 conceptually illustrated setting the scope for “maximum-minimum of the number of works assignable” and the “number of setup conditions for works”.

Because productivity declines, as the number of works assignable varies to a larger extent, the parameter, “maximum-minimum of the number of works assignable” is made to vary between the largest value (worst) and the smallest value (best).

Because productivity declines, as the “number of setup conditions for works” becomes larger, the parameter, the “number of setup conditions for works” is made to vary between the largest value (worst) and the smallest value (best).

Production data for testing typically includes products to be produced and their quantity and delivery date, but sometimes includes no noticeable characteristic parameters directly. In that case, noticeable characteristic parameters should be correlated with production data for testing based on master information stored in the master information storage unit 111.

As for “maximum-minimum of the number of works assignable”, it is made available by identifying an equipment for use for products to be produced, specified in production data for testing, from the process master 1111 (FIG. 2) and calculating a difference between the maximum and minimum values of capacity of a buffer of the equipment from the equipment master 1112 (FIG. 3).

As for the “number of setup conditions for works”, a search is made for its count through the setup master 1113 (FIG. 4) based on products to be produced, specified in production data for testing. For instance, if “ProdA”, “ProdB”, and “ProdC” are products to be produced, the number of setup conditions is 3 and setup is required at least two times; this is regarded as a lot of times of setup operations (worst). Also, if a product to be used is only “ProdA”, the number of setup conditions is 1 and the number of setup operations required is 0; this is regarded as fewer times of setup operations (best). If the master is more complex, the number of setup conditions may be determined using the attributes of products.

Then, the test production data generation unit 123 defines test points by setting grid points within the set scope of value variation of the noticeable characteristic parameters (S602). B in FIG. 11 conceptually illustrates setting the test points. Although grid points may be set in any way, for example, the set scope of value variation of the noticeable characteristic parameters will be divided into a certain number of evenly spaced parts (e.g., four parts).

Then, the test production data generation unit 123 generates production data by the same or closest condition for each test point as production data for testing. C in FIG. 11 conceptually illustrates the generation of production data for testing. From master information, production data for testing is generated as data having a combination that is close to the value of a noticeable characteristic parameter of each test point. For example, a combination of “ProdA” and “ProdB” as products to be produced is generated from the setup master 1113 for a point for which the number of setup conditions is 2. If there is a plurality of production data obtained by the same condition, a selection should expediently be made randomly or based on a predetermined rule.

If production data for testing includes no noticeable characteristic parameters, as discussed previously, noticeable characteristic parameters may be correlated with production data for testing beforehand by referring to master information in the master information storage unit 111. Alternatively, production data that is the same as or close to the noticeable characteristic parameter of a test point may be generated each time from master information. As for how to select those that are closest to the value of a test point, a thorough search through all combinations should expediently be performed as a simple way. Other search methods which are publicly known may be used.

Then, descriptions are provided about a man-machine interface in this embodiment. The productivity reduction factor display unit 124 and the test case list display unit 125 in FIG. 1 aid a user to generate production data for texting. The productivity reduction factor display unit 124 and the test case list display unit 125 cause information that is rendered to a user to be displayed on, inter alia, a display of the output unit 140. The productivity reduction factor display unit 124 and the test case list display unit 125 accept user input from, inter alia, a keyboard of the input unit 130.

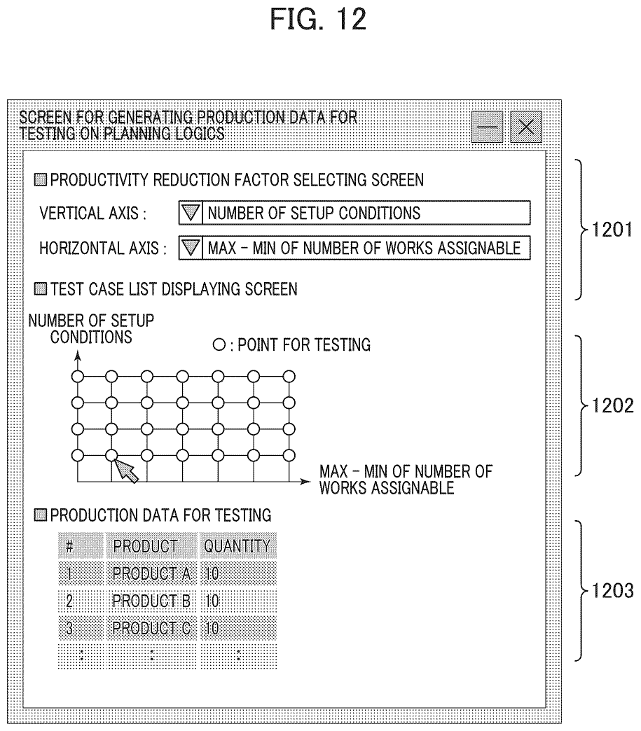

FIG. 12 is an image diagram of a screen for generating production data for testing on planning logics being displayed on the output unit 140.

The productivity reduction factor display unit 124 displays noticeable characteristic parameters regarded as the factors causing productivity reduction, extracted as a result of analysis of productivity reduction factors (S500) in a productivity reduction factor selecting screen 1201. The user is allowed to select noticeable characteristic parameters as test point plotting axes. Although two axes are taken in the embodiment described hereinbefore, a selection may be made of one axis or three axes.

The test case list display unit 125 displays an image corresponding to C in FIG. 11 in a test case list displaying screen 1202.

When the user specifies a test point, the test case list display unit 125 displays the contents of relevant production data for testing in a test production data displaying screen 1203.

Generated production data for testing is stored in a test production data storage unit 114. An efficient evaluation of planning logics is made possible by inputting production data for testing to the production scheduler of the production planning system 300 and evaluating a production plan that has been output.

As described hereinbefore, we has made a proposal of a planning logic evaluation support device in this embodiment; the planning logic evaluation support device is characterized by including a process characteristic extraction unit to extract process characteristics from master data, a productivity reduction factor extraction unit to extract factors causing productivity reduction based on the process characteristics; and an automatic test production data generation unit to generate production data for testing in which the factors are parameterized and dispersed based on the factors causing productivity reduction. Testing on circumstances where productivity is liable to decline has so far required know-how. According to the technology of this embodiment, taking notice of a fact that there is a correlation between process flow characteristics and productivity reduction factors, it is possible to implement testing without know-how by extracting factors causing productivity reduction from a process flow and generating production data for testing in which the factors are parameterized and dispersed in a certain scope. This enables those other than experts to evaluate planning logics and facilitates scheduler introduction.

According to the embodiment described hereinbefore, it is possible to implement efficient production planning; this can contribute to realization of a sustainable society with low power consumption, reduction of carbon emissions, and prevention of global warming.

### LIST OF REFERENCE SIGNS

121: process characteristic analysis unit 121

122: productivity reduction factor analysis unit

123: test production data generation unit

124: productivity reduction factor display unit

1225: test case list display unit

111: master information storage unit

112: process characteristic library storage unit

113: productivity reduction factor library storage unit

114: test production data storage unit

1. A planning logic evaluation support system equipped with a control unit, a storage unit, an input unit, and an output unit and comprising:
a process characteristic analysis unit to extract process characteristics from master data;
a productivity reduction factor extraction unit to extract noticeable characteristic parameters that have an effect on productivity based on the process characteristics; and
a test production data generation unit to generate production data for testing in which the noticeable characteristic parameters are dispersed in a certain scope.

2. The planning logic evaluation support system according to claim 1 wherein
the storage unit comprises a productivity reduction factor library storage unit to store productivity reduction factor data in which the process characteristics and the noticeable characteristic parameters are correlated and the productivity reduction factor extraction unit extracts noticeable characteristic parameters by referring to the productivity reduction factor data.

3. The planning logic evaluation support system according to claim 2 further comprising a productivity reduction factor display unit, wherein
the productivity reduction factor display unit has a function of displaying the extracted noticeable characteristic parameters and allowing a user to select one or a plurality of ones of them.

4. The planning logic evaluation support system according to claim 3 further comprising a test case list display unit, wherein
the test case list display unit assigns the noticeable characteristic parameters selected by the user to axes and maps and displays production data for testing to the user.

5. The planning logic evaluation support system according to claim 4, wherein,
as for the noticeable characteristic parameters in a certain scope,
the test production data generation unit generates a test case in which the values of the noticeable characteristic parameters disperse.

6. The planning logic evaluation support system according to claim 5, wherein
the test production data generation unit generates production data for testing having values that are the same as or closest to the noticeable characteristic parameters in the test case.

7. The planning logic evaluation support system according to claim 1, wherein
the storage unit comprises a process characteristic library to store the process characteristics as element patterns, and the characteristic analysis unit generates a process patterned from the master data, compares the process against the element patterns, and extracts characteristics of the process.

8. A planning logic evaluation support method that is executed by an information processing device equipped with a control unit, a storage unit, an input unit, and an output unit, the method comprising:
a process characteristic analysis step to extract process characteristics from master data; a productivity reduction factor extraction step to extract noticeable characteristic parameters that have an effect on productivity based on the process characteristics; and
a test production data generation step to generate production data for testing in which the noticeable characteristic parameters are dispersed in a certain scope.

9. The planning logic evaluation support method according to claim 8 wherein
the storage unit comprises a productivity reduction factor library storage unit to store productivity reduction factor data in which the process characteristics and the noticeable characteristic parameters are correlated, and
the productivity reduction factor extraction step extracts noticeable characteristic parameters by referring to the productivity reduction factor data.

10. The planning logic evaluation support method according to claim 9 further comprising
a productivity reduction factor display step, wherein the productivity reduction factor display step displays the extracted noticeable characteristic parameters and allows a user to select one or a plurality of ones of them.

11. The planning logic evaluation support method according to claim 10 further comprising a test case list display step, wherein
the test case list display unit assigns the noticeable characteristic parameters selected by the user to axes and maps and displays production data for testing to the user.

12. The planning logic evaluation support method according to claim 11, wherein,
as for the noticeable characteristic parameters in a certain scope,
the test production data generation step generates a test case in which the values of the noticeable characteristic parameters disperse.

13. The planning logic evaluation support method according to claim 12, wherein
the test production data generation unit generates production data for testing having values that are the same as or closest to the noticeable characteristic parameters in the test case.

14. The planning logic evaluation support method according to claim 13, wherein
the storage unit comprises a process characteristic library to store the process characteristics as element patterns, and
the characteristic analysis step generates a process patterned from the master data, compares the process against the element patterns, and extracts characteristics of the process.

15. The planning logic evaluation support method according to claim 13, wherein
the test production data generation unit generates production data for testing having values that are the same as or closest to the noticeable characteristic parameters in the test case based on the master data.
